(19) United States
(12) Patent Application Publication
(10) Pub. No.: US 2004/0112879 A1
(43) Pub. Date: Jun. 17, 2004

(54) Identification-code laser marking method and apparatus

(76) Inventors: Masaki Mori, Otsu-shi (JP); Takeshi Tsuneyoshi, Otsu-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/679,358

(22) Filed: Oct. 7, 2003

(30) Foreign Application Priority Data
Dec. 16, 2002 (JP) JP2002-363698

(51) Int. Cl. B23K 26/067

(52) U.S. Cl. 219/121.69; 219/121.77

(57) ABSTRACT

To provide an identification-code laser marking method and apparatus for forming a mark constituted of at least either one dimension or two dimension with time series dots on a substrate by using at least one acoustooptic deflector and thereby scanning at least either a horizontal plane or a vertical plane with a laser beam emitted from a laser oscillator and thereafter irradiating the mark so as to two-dimensionally scan the mark by using a galvanometer scanner.

### BACKGROUND OF THE INVENTION

The present invention relates to an identification-code laser marking method and apparatus, more particularly to a laser marking method and apparatus for exposing an identification code for a history control or a quality control on a photoresist-coated substrate by a laser beam or similarly engraving an identification code on a substrate such as a wafer in a liquid crystal panel manufacturing process.

Generally, in a liquid crystal panel manufacturing process, a circuit pattern is exposed to a photoresist-coated substrate obtained by applying a predetermined photoresist to a glass substrate by an identification aligner, a substrate identification code or panel identification code is exposed to the photoresist-coated substrate by an identification aligner, and an unnecessary resist portion around a substrate is exposed to the photoresist-coated substrate by a peripheral aligner respectively by ultraviolet light and the substrates finishing the above exposures are developed by a developing machine. The above-described identification code is used for a history control or a quality control in every manufacturing process, for which two-dimensional codes or characters are generally used.

As a conventional laser marking apparatus of an identification-code, an apparatus disclosed in the official gazette of Japanese Patent Laid-Open No. (Hei) 11-231547 or 11-271983 is known. The laser marking apparatus performs marking by two-dimensionally swinging a laser beam output from a laser oscillator by a scanner such as a galvanometer scanner, and thereby applying a mark such as a character or a figure on an object. However, the laser marking apparatus has a problem of easily causing an identification-code read error because it requires a lot of time for marking and the positioning accuracy on a marking face of a laser-beam scanned by a galvanometer scanner is not high.

That is, because a conventional laser-beam marking apparatus is provided with only a galvanometer scanner for a scanning, the positioning accuracy is low. As a result, as sown in FIG. 6, a variation within the positions of dots constituting a two-dimensional code easily causes an error when reading the two-dimensional code. Moreover, a considerably long time is required to mark the whole identification code because the time required for marking depends on the operation time of the galvanometer scanner and a general operation time of the galvanometer scanner from the end of marking one dot to the beginning of marking another requires several milliseconds.

### SUMMARY OF THE INVENTION

It is an object of the present invention to provide a laser marking method and apparatus capable of decreasing the time for marking the whole identification mark without causing a read error when reading an identification code.

A laser marking method of the present invention for achieving the above object is characterized that a laser beam emitted from a laser oscillator forms a mark constituted of at least either one dimension or two dimension dots formed in order by using at least one acoustooptic deflector. Thereby the laser beam scans at least either a horizontal plane or a vertical plane and then two-dimensionally scans the mark on a substrate with a galvanometer scanner.

Moreover, a laser marking apparatus of the present invention for achieving the above object is constituted of a laser oscillator, at least one acoustooptic deflector for forming a mark constituted of at least either one dimension or two dimension dots formed in order by scanning at least either a horizontal plane or a vertical plane with a laser beam emitted from the laser oscillator, and at least one galvanometer scanner mechanism for irradiating the mark so as to two-dimensionally scan the mark on a substrate.

As described above, by using an acoustooptic deflector and thereby scanning at least either a horizontal plane and a vertical plane with a laser beam, it is possible to improve the positioning accuracy of dots constituting an identification code and realize a high-speed marking.

An acoustooptic deflector makes it possible to deflect a laser beam corresponding to the frequency of an electrical signal to be applied to the deflector. Therefore, the accuracy of the deflection angle of the acoustooptic deflector is superior to that of a galvanometer scanner. Moreover, it is possible to change the deflecting operation of the acoustooptic deflector to the next deflection angle at a high speed between several nanoseconds and several microseconds. Though it is allowed to use one set of acoustooptic deflectors, it is preferable to combine two sets of acoustooptic deflecting units. By combining two sets of acoustooptic deflector, it is possible to form an optional complex character or figure.

Moreover, it is possible to further improve the positioning accuracy of dots constituting an identification code, by setting a focus mechanism between an acoustooptic deflector and a galvanometer scanner mechanism for correcting a focal distance shift due to a scanning by the galvanometer scanner mechanism and making the lens of the focus mechanism synchronize with the scanning by the galvanometer scanner,.

Moreover, by using a plurality of galvanometer scanner mechanisms, it is possible to realize a plurality of scanning ranges of a galvanometer scanner.

The present invention can be used not only for an exposure of an identification code for a history control or a quality control to a photoresist-coated substrate in a liquid crystal panel manufacturing process with a laser beam but also for a laser marking of similar engraving of an identification code on a substrate such as a wafer.

### BRIEF DESCRIPTION OF THE DRAWINGS

FIG. 1 is a perspective view showing an embodiment of a laser marking apparatus according to the present invention;

FIG. 2 is a perspective view showing another embodiment of a laser marking apparatus according to the present invention;

FIG. 3 is a perspective view showing still another embodiment of a laser marking apparatus according to the present invention;

FIG. 4 is a perspective view showing a state in which a laser beam enters or exits an acoustooptic deflector used for the present invention;

FIG. 5 is an illustration showing a mark formed by two-dimensionally scanning a substrate with a laser beam by a laser marking apparatus according to the present invention; and

FIG. 6 is an illustration showing a mark formed by two-dimensionally scanning a substrate with a laser beam by a conventional laser marking apparatus.

### DESCRIPTION OF THE PREFERRED EMBODIMENTS

The preferred embodiments are specifically described below by referring to the illustrated embodiments of the present invention.

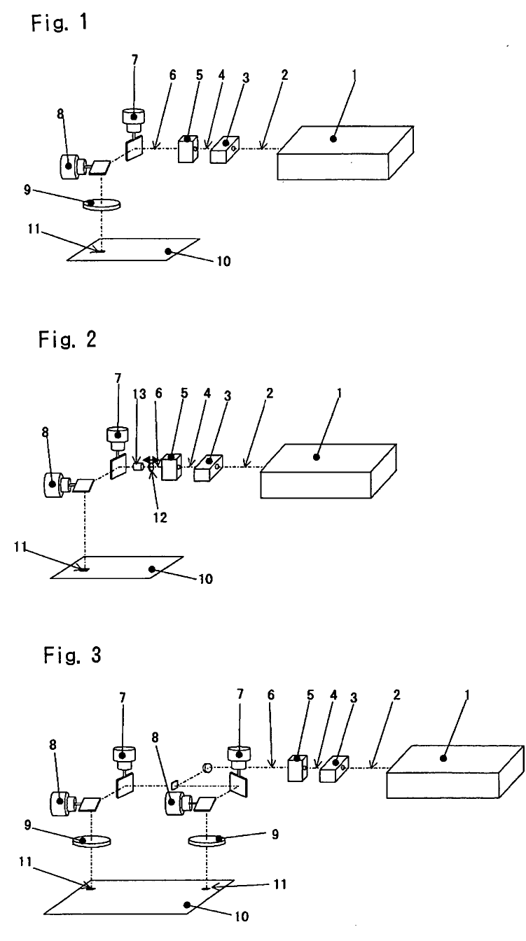

FIG. 1 illustrates a laser marking apparatus constituted by an embodiment of the present invention.

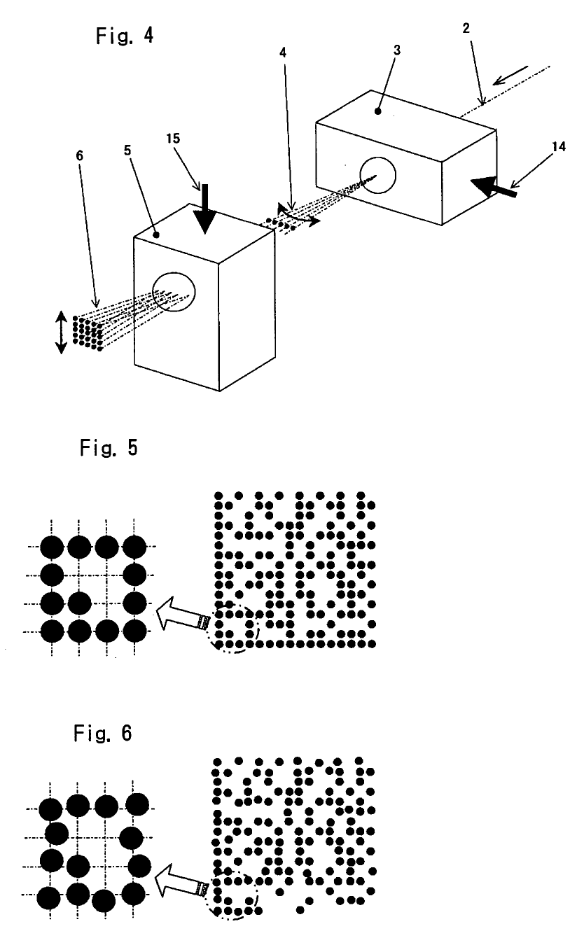

A laser beam 2 emitted from a laser oscillator 1 is adjusted in predetermined beam diameter and collimation and enters an X acoustooptic deflector 3 as shown in FIG. 4. The laser beam entering the X acoustooptic deflector 3 exits as a laser beam 4 from the unit 3 deflected in accordance with the frequency of an X applied electrical signal 14. It is a matter of course that the laser beam 4 is not divided into a plurality of beams but its deflection angles are changed corresponding to a time-series change of the frequency of the X applied electrical signal 14.

Then, the laser beam 4 enters the Y acoustooptic deflecting unit 5 and exits from the unit 5 as a laser beam 6 deflected in accordance with the frequency of the Y applied electrical signal 15. In this case, by setting the above mentioned X acoustooptic deflector 3 and the Y acoustooptic deflector 5 so as to be orthogonal each other and swinging the laser beam 4 deflected in the horizontal direction in the vertical direction by the Y acoustooptic deflector 5, it is possible to two-dimensionally change angles of the laser beam 6. That is, by controlling the X applied electrical signal 14 and the Y applied electrical signal 15 with respect to the acoustooptic deflector 3 and 5. It is possible to constitute an optional character or figure with dots formed in order. As a result, as shown in FIG. 5, it is possible to obtain a two-dimensional code very accurate in positioning of dots.

By applying a mark of a character or figure to an optional position on a liquid crystal glass substrate 10 by an X galvanometer scanner 7 and a Y galvanometer scanner 8, it is possible to mark an identification code 11. In this case, it is preferable to use an f θ lens 9 in order to adjust a focal distance,.

In the case of the present invention, it is allowed to use a mirror, lens, and wavelength plate if necessary, which are not shown in the illustrated embodiments. It is possible to realize even either the X acoustooptic deflector 3 and the Y acoustooptic deflector 5 when it is sufficient that marking is one-dimension. Moreover, it is allowed to use a two-dimensional acoustooptic deflector constituted of integrating the X acoustooptic deflector 3 and the Y acoustooptic deflector 5 as one deflector.

Moreover, like the embodiment shown in FIG. 2, in stead of the f 0 lens 9, an objective 13 may be disposed in front of the X galvanometer scanner 7, the focus lens 12 which compensate a shift of a focal distance caused by scanning by the X galvanometer scanner 7 and the Y galvanometer scanner 8, may be used to synchronize with the movement of the scanning by the X galvanometer scanner 7 and the Y galvanometer scanner 8.

Moreover, as shown by the embodiment in FIG. 3, it is possible to arrange a plurality of scanning ranges of the galvanometer scanner mechanisms by disposing a plurality of galvanometer scanner mechanisms constituted of the X galvanometer scanner 7 and the Y galvanometer scanner 8 as a galvanometer scanner after a laser beam exits the acoustooptic deflector. Moreover, a scanning range also may be divided into plural at any right location after the laser beam is emitted from the laser oscillator 1.

As described above, according to the present invention, the problem of the positioning accuracy of a two-dimensional code on an object to be marked still remains because of the positioning accuracy of a galvanometer scanner. However, because dots constituting the two-dimensional code are formed by acoustooptic deflectors of two axes of X and Y, dot positions don't shift in the two-dimensional code and thus, it is possible to mark a two-dimensional code with high readout rate. Moreover, when marking dots with a conventional galvanometer scanner, the period from the end of marking one dot to the beginning of another requires at least several milliseconds. According to the present invention, however, the period from the end of marking one dot to the beginning of another requires several microseconds at most because the method of time series dot marking is performed with an acoustooptic deflector. Therefore, it is possible to decrease the period to 1/1,000 compared with the case of a conventional method.

What is claimed is:

1. A laser marking method of an identification-code, comprising the steps of; forming a mark constituted of at least either one dimension or two dimension on a substrate with dots formed in order by scanning on at least either a horizontal plane or a vertical plane with a laser beam emitted from a laser oscillator by using at least one acoustooptic deflector, and then irradiating the mark so as to two-dimensionally scan the mark on a substrate by using a galvanometer scanner.

2. The laser marking method of an identification-code according to claim 1, wherein the substrate uses a photoresist-coated substrate.

3. A laser marking apparatus of an identification-code comprising a laser oscillator, at least one acoustooptic deflector for forming a mark constituted of at least either one dimension or two dimension with dots formed in order by scanning at least either a horizontal plane or a vertical plane with a laser beam emitted from the laser oscillator, and at least one galvanometer scanner mechanism for irradiating the mark so as to two-dimensionally scan the mark on a substrate.

4. The laser marking apparatus of an identification-code according to claim 3, wherein a focus mechanism for correcting a shift of a focal distance caused by the scanning with the galvanometer scanner mechanism is interposed between the acoustooptic deflector and the galvanometer scanner mechanism.

5. The laser marking apparatus of an identification-code according to claim 3 or 4, comprising a plurality of galvanometer scanner mechanisms.

6. The laser marking apparatus of an identification-code according to claim 3 or 4, wherein the substrate uses a photoresist-coated substrate.

7. The laser marking apparatus of an identification-code according to claim 5, wherein the substrate uses a photoresist-coated substrate.
